(19) United States
(12) Patent Application Publication
(10) Pub. No.: US 2005/0164528 A1
(43) Pub. Date: Jul. 28, 2005

(54) Molded parts winding manufacture

(76) Inventor: Werner Furguth, Altdorf (DE)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/013,139

(22) Filed: Dec. 14, 2004

(30) Foreign Application Priority Data
Dec. 17, 2003 (EP) 03 028 980.5

(51) Int. Cl. H01R 12/00

(52) U.S. Cl. 439/71

(57) ABSTRACT

A method of manufacturing a winding of an electric machine out of molded winding parts which have connecting surfaces for soldering includes placing of one or several molded parts on an already built layer of already soldered together molded parts such that at in each case at least two connecting surfaces which are to be soldered together, with solder between them, come to lie at a connecting place; pressing of at least two resistance soldering electrodes onto the exposed top side of the upper one of the molded parts which are to be connected, whereby the bottom one of the molded parts which are to be connected is pressed against the layer already built; applying a voltage to the resistance soldering electrodes so that a soldering current flows in the upper molded part.

### CROSS-REFERENCE TO RELATED APPLICATIONS

The present patent application claims priority from European Patent Application No. 03 028 980.5, filed on Dec. 17, 2003.

### FIELD OF THE INVENTION

The invention is related in general to manufacturing of molded parts windings and, for example, to a method of manufacturing a winding of an electric machine by soldering molded parts.

### BACKGROUND OF THE INVENTION

In electric machines the stator and/or the rotor is generally equipped with a winding. In a polyphase machine (asynchronous or synchronous machine) the current flowing through the stator winding generates a rotating magnetic field which exerts a torque on the rotor. Conventionally the winding is made out of wire wound coils. These are located in the region of the so-called coil sides in grooves of the stator body. Because the wire cross-section is usually circular, the filling factor is in most cases less than 50% in the generally rectangular grooves.

A known method for increasing the filling factor is not to construct the winding with wire, but instead with molded parts having groove rods with cross-sections adapted to match the groove cross-section. For example, such a winding assembled with L-shaped molded parts is disclosed in U.S. 2004/0046475 A1 assigned to the present assignee. Since the coils belonging to the different branches of the machine (i.e. to the different phases) are arranged to be overlapping, the molded parts winding is built such that the molded parts are inserted into the stator grooves by layers (and not by coils) and then electrically interconnected. For connecting the individual molded parts it is specified that this can be done by soldering, welding, brazing or stamp piling. Laser welding is described in detail; thereby in each case one half of the molded parts of a winding layer are inserted, and then the individual molded parts are laser welded at the envisaged connecting points to the already inserted molded parts of the layer below or of the same layer.

In WO 01/95462 A1 a method is disclosed for manufacturing a similar molded parts winding in which first all molded parts of the winding are fitted and only thereafter all electric connections which have to be made on one or both winding sides are made in a single process step by flood or dip soldering.

In DE 28 36 731 a method is disclosed for soldering components onto large area metal sheets by resistance soldering. Thereby the component which is to be soldered-on is pressed against the metal sheet from one side (it is assumed that the metal sheet is thereby placed on a support for absorbing the reaction force). On the other side a plurality of independently spring-loaded electrodes is brought into contact with the metal sheet. An electric current flowing through the electrodes and the metal sheet heats the metal sheet so that the component located on the other side of the metal sheet is soldered-on.

In DD 256 470 A1 a resistance soldering method is disclosed in which a soldering components packet is contacted on each opposite side by a respective soldering electrode. Thus the soldering current flows via the interface between the parts which are to be soldered.

JP 09-097632 discloses a method for welding (not soldering) an electric wire with an I-shaped connecting tab which surrounds the wire. The welding is accomplished, for example, by placing a welding electrode onto the top side of the connecting tab and another welding electrode onto the wire adjacent to the connecting tab.

FR 2 808 938 A1 discloses a method for manufacturing a molded parts winding whereby the molded parts are assembled by soldering to produce a winding. The open ends of the molded parts are soldered by contacting two electrodes, one on one of the molded parts and the other on the other molded part. The two electrodes press from opposite sides onto the molded parts which are to be soldered together. The heating current flows via the boundary contact area which is to be soldered between the molded parts.

### SUMMARY OF THE INVENTION

The invention is directed to a method of manufacturing a winding of an electric machine out of molded winding parts which have connecting surfaces for soldering. The method comprises: placing of one or several molded parts on an already built layer of already soldered together molded parts such that at in each case at least two connecting surfaces which are to be soldered together, with solder between them, come to lie at a connecting place, whereby the top side of the upper one of the molded parts which are to be connected is exposed in the region of the connecting place; pressing of at least two resistance soldering electrodes onto the exposed top side of the upper one of the molded parts which are to be connected, in the region of the connecting place which is to be soldered, whereby the bottom one of the molded parts which are to be connected is pressed against the layer already built and thus the molded parts which are to be connected are pressed together at the connecting place by the resistance soldering electrodes; applying a voltage to the resistance soldering electrodes so that a soldering current flows in the upper molded part and the resistance heating thereby produced solders together the molded parts at the connecting place.

According to another aspect, a method is provided of manufacturing a winding of an electric machine out of molded winding parts which have connecting surfaces for soldering. The method comprises: placing of one or several molded parts on an already built layer of already soldered together molded parts such that at a connecting place which is to be soldered a connecting surface of one molded part of the already built layer and a connecting surface of the, or one of the, newly mounted molded parts come to lie on top of each other with solder in between them, whereby the top side of the upper one of molded parts which are to be connected is exposed in the region of the connecting place; pressing of at least two resistance soldering electrodes onto the exposed top side of the upper one of the molded parts which are to be connected, in the region of the connecting place which is to be soldered, whereby the bottom one of the molded parts which are to be connected is pressed against the layer already built and thus the molded parts which are to be connected are pressed together at the connecting place by the resistance soldering electrodes; applying a voltage to the resistance soldering electrodes so that a soldering current flows in the upper molded part and the resistance heating thereby produced solders together the molded parts at the connecting place.

According to another aspect, a method is provided of manufacturing an electric machine with a stator and a rotor, whereby the stator is equipped with a molded parts winding made according to the following method, comprising: placing of one or several molded parts on an already built layer of already soldered together molded parts such that at in each case at least two connecting surfaces which are to be soldered together, with solder between them, come to lie at a connecting place, whereby the top side of the upper one of the molded parts which are to be connected is exposed in the region of the connecting place; pressing of at least two resistance soldering electrodes onto the exposed top side of the upper one of the molded parts which are to be connected, in the region of the connecting place which is to be soldered, whereby the bottom one of the molded parts which are to be connected is pressed against the layer already built and thus the molded parts which are to be connected are pressed together at the connecting place by the resistance soldering electrodes; applying a voltage to the resistance soldering electrodes so that a soldering current flows in the upper molded part and the resistance heating thereby produced solders together the molded parts at the connecting place; and whereby the stator equipped with the winding is assembled with the rotor to make an electrical machine.

Other features are inherent in the disclosed products and methods or will become apparent to those skilled in the art from the following detailed description of embodiments and its accompanying drawings.

### BRIEF DESCRIPTION OF THE DRAWINGS

Embodiments of the invention will now be described, by way of example, and with reference to the accompanying drawings, in which:

FIG. 1 illustrates a soldering process as a cross-section view of winding layers and soldering electrodes placed on a molded part of the topmost winding layer;

FIG. 2 is a flow chart of the soldering process;

FIG. 3 is an example of a winding configuration of a polyphase winding with overlapping coils;

FIG. 4 shows two different examples of molded part types as perspective view and as cross-section view;

FIG. 5 is a perspective view of a winding layer in the course of being constructed;

FIG. 6 is a perspective view showing a stator section of an electric machine with a molded part winding in the course of being constructed;

FIG. 7 is a perspective partial view of a stator equipped with the complete winding;

FIG. 8 sketches a starter generator equipped with such a winding.

### DESCRIPTION OF THE PREFERRED EMBODIMENTS

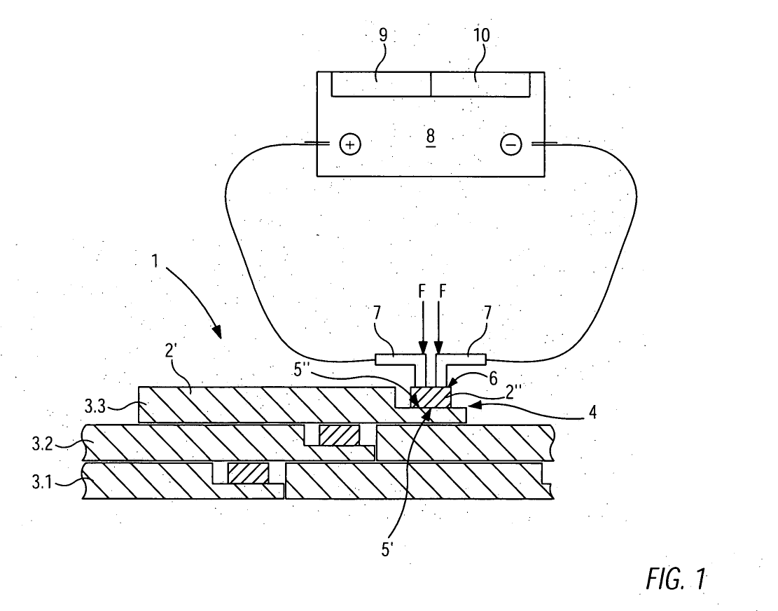

FIG. 1 illustrates a soldering process as a cross-section view of winding layers and soldering electrodes placed on a molded part of the uppermost winding layer. First of all various explanations with regard to the embodiments now follow before a detailed description of FIG. 1.

In the embodiments the molded parts which are to be connected together are soldered, that is they are connected together by melting a metal brought into the soldering gap. In some embodiments the working temperature lies below 450° C. and correspondingly a solder (e.g. on the basis of Zn and/or Pb) is used which melts at a temperature below 450° C.; these embodiments thus utilize a soft soldering process.

When placing—as will be described in detail below—a new layer of molded parts onto an already built layer of molded parts which have already been soldered together, the connecting surfaces which are to be soldered together come to lie on each other. The required solder is already present between the connecting surfaces before the actual soldering process. In these embodiments two resistance soldering electrodes are then pressed against the exposed top side of the upper one of the molded parts which are to be connected, in the region of the connecting place which is to be soldered. The reaction force in response to this pressing force is exerted by the one or more underlying already built layers of molded parts. This presses together the molded parts which are to be connected, at the connecting place. No further mechanism is provided in the embodiments for pressing together the molded parts at the connecting place; that is to say, pressing together is achieved solely by the soldering electrodes. Finally, a voltage is applied to the pressed-on resistance electrodes so that a soldering current flows through the upper molded part, and the resistance heating thereby produced solders together the molded parts at the connecting place.

Of course, pressing-on the resistance electrodes and applying the voltage to them need not take place in this order. For example, the voltage can be applied already at the instant of pressing-on; in principle it is even possible to press electrodes, to which voltage is already applied, onto the molded part.

In the embodiments all soldering electrodes serving for soldering a given connecting place (two soldering electrodes are involved in the depicted embodiments, but more than two electrodes could be involved) are placed onto the upper one of the molded parts which are to be connected, in the region of the connecting place. This has the effect that the soldering current chiefly flows only in the upper molded part. At most a small fraction of the current will take a current path which twice crosses the boundary surface which is to be soldered, so that a part of the current path lies in the lower molded part. Consequently most of the direct resistive loss heating takes place in the upper molded part, whereas the lower molded part is heated only indirectly by thermal conduction across the boundary surface.

When several electrodes are pressed-on at the connecting place, the individual electrode forces add. As has already been mentioned, the electrode force also serves to press the connecting surfaces together, thus not only to establish electric contact between the electrode and the molded part, therefore it is greater than would be required only for making electric contact. For example, in some embodiments the total electrode force per soldering location is 0.1 kN to 0.3 kN (thus in the case of two electrodes 0.05 kN to 0.15 kN per electrode). Typical forces for establishing electric contact lie around 0.01 kN to 0.02 kN per electrode (kN=kilo-Newton).

In some embodiments the molded parts are provided with an insulating surface, for example a layer or insulating enamel or a non-conducting oxide layer. However, in these embodiments the surface is not insulated in certain places where it is conducting instead. These places are the connecting surfaces on the one hand and, on the other hand, the places where the soldering electrodes are pressed onto the molded part. After soldering, these non-insulated places on the top side of the molded parts no longer serve any function. Theoretically the missing insulation on the top sides of the molded parts constitute places of weakness, because the next layer of molded parts is placed onto these top sides. However, it has been found that, in contrast to the conditions in the case of a welded connection, soldering does not involve any melting of the molded part material, so that no material spikes or the like are formed on the molded part top side and therefore the insulating surface layer on the underside of the molded part which comes to lie on the insulation-free top side constitutes adequate insulation. Therefore in some embodiments the stated places remain without insulation in the finished winding; thus no insulating paper or the like, or insulating lacquer, is applied after making the soldered connection.

The solder for establishing the soldered connection is already present between the connecting surfaces before the resistance heating, thus it is heated together with the molded parts which are to be connected. In some of the embodiments one molded part or both molded parts are plated (tinned) with solder on the connecting surface before the molded parts are installed and soldered. If necessary, a flux can also be applied to the connecting surfaces. In other embodiments the solder (if appropriate, with flux) is applied to the connecting surface of the molded parts, for example as soldering powder or soldering paste, when or before mounting and before the resistance heating.

In some embodiments the pressing force of the soldering electrodes is sustained after termination of voltage application at least until the solder has solidified.

Regarding these embodiments, the production of a molded parts winding of the type described in U.S. 2004/0046475 A1 will now be described in detail as example. In this type of winding the coils belonging to the various phases are arranged in overlapping configuration. Correspondingly, the winding is not built-up in the form of individual coils constructed successively in the stator which is to be equipped with the winding; instead the complete winding is built-up in layers with the individual molded parts. The connecting places of the molded parts are in each case covered by a new layer or partial layer of molded parts. Apart from their face sides, the molded parts are thus accessible from one side only as long as the molded parts of the next layer or partial layer have not yet been mounted on top of them. For example, in internal rotor machines the stator grooves are open towards the axis of the machine, in which case the winding built-up in layers takes place from the outside to the inside, towards the axis, so that the respectively accessible molded parts side is the side facing towards the axis (the accessible side is also called the “top side” in this description). The soldering of the individual molded parts is then carried out when the connecting places are still accessible on the top side; thus it is carried out, for example, in layers or in partial layers too. It is thereby possible to alternately place all molded parts of a new layer or partial layer onto an already built-up layer and then to establish the electrical connections belonging to this layer. Alternatively it is also possible to place only parts of a layer or partial layer (for example only a single molded part) at a time onto the already built-up layer and then to make the associated soldered connections immediately.

In general every molded part has a connecting surface on each of its two ends. In some embodiments the molded parts are L-shaped and thus comprise a groove rod which is to be inserted in a groove of the stator and, at right angles to this rod, a connecting conductor section which runs in a tangential direction outside the stator and serves for making the connection to the other coil side of the particular coil. In each case two such L-shaped molded parts constitute one turn of a coil; a coil is formed by helical stacking of a plurality of such turns. In some of the embodiments the two groove rods of a turn lie at the same height, i.e. at the same radial distance from the axis of the machine. Accordingly there are two different types of connections: The first type connects the particular molded part with the turn which lies above or below; the second type connects the two molded parts of a turn. The collective of all turns on the same height constitutes a winding layer (also called a “molded parts layer”).

In other embodiments molded parts other than L-shaped ones are used, for example straight extended molded parts (“I molded parts”), which for example constitute only the groove rods or only the connecting conductors. Accordingly, twice as many electrical connections must be made here, compared with a winding constructed with L-shaped molded parts. To build-up the winding, the groove rods are inserted in layers into the grooves of the stator; a connecting conductor is then soldered onto two inserted groove rods at a time. U-shaped molded parts, for example, are also possible, whereby the bottom of the “U” is inserted into the stator grooves and the legs of the “U” are soldered together with the U-legs of other molded parts to make the connecting conductors. Furthermore, the following and above statements with regard to windings made out of L-shaped molded parts also apply to such windings made out of I-shaped and U-shaped molded parts, for example with regard to build-up of the winding in layers and covering of the connecting places by the layers lying above them.

In the case of overlapping coil configuration the connecting conductors of the plurality of coils pass each other on the outside of the stator. Although it is fundamentally possible to bundle the connecting conductors of the individual coils and to implement this passing by with a deflection of these bundles (for example in the axial direction), in some embodiments the connecting conductors of different coils are arranged such that they overlap in a comb-like configuration. For this purpose the molded parts are constructed such that the height of the molded part in the connecting conductor region is less than in the groove rod region. For example, when the connecting conductors of three coils overlap, the height of an individual connecting conductor is about one third of the height of the groove rod, so that in the connecting conductors region three times as many conductors as respectively for the groove rod can be stacked above each other. In some embodiments the connecting conductors are made correspondingly wider, for example three times as wide as the groove rods, to avoid a reduction of the conductor cross section.

To ensure that the connections to be made between the individual molded parts do not make the connections thicker, the heights of the molded parts are reduced in the region of the connecting places. For example, the groove rods have flattened tongues on their ends projecting out of the grooves; the larger area connecting conductors have respective depressions which mate with the flattened groove rod tongue without thickening.

In some embodiments the connecting conductors thus have a smaller height than the groove rod and, as compensation, they are made wider than the groove rod; thus altogether the connecting conductor has a “greater area” than the groove rod. In some of these embodiments the winding is constructed such that at the connecting place the larger area molded part in each case lies at the bottom and the smaller area molded part lies at the top; this gives a better distribution of the electrode forces exerted on the layer lying below and thus reduces the danger of damaging the electrical insulation of this layer.

In the laser welding process chiefly employed so far according to the state of the art, the upper molded part over the connecting place is melted by the laser beam. The thickness of the molded part over the connecting place in the laser welding process is, for example, 0.4 mm. It has now been found that with the soldering process described above significantly thicker molded parts can be connected together than with the mentioned laser welding process which melts the upper molded part at the connecting place. For example, in some embodiments the thickness of the upper molded part at the connecting place is at least 0.65 mm, in other embodiments at least 0.9 mm and in yet other embodiments even at least 1.2 mm or as much as at least 1.5 mm. The thickness of the upper molded part at the connecting place depends on the height of the groove rod: As already explained above, in the overlapping configuration of the individual coils the connecting conductor can be made flatter than the groove rod, to make possible the passing by of the connecting conductors of the respective other coils. For example, if at most three coils at a time overlap, the height of the connecting conductor is approximately a third of the groove rod height. For the embodiments in which the connecting place is located in the connecting conductor region, only the connecting conductor height is available at the connecting place for the two molded parts together which are to be connected at the connecting point; this means that the two molded parts share the connecting conductor height. If, for example, the height is shared equally, the groove rod is, for example, higher by a factor of 6 than the upper molded part at the connecting place. For example, if the thickness of the upper molded part at the connecting place is only 40% of the connecting conductor height, and that of the lower connecting part is 60% thereof, then the mentioned factor is 7.5. For example, if according to the state of the art the thickness of the upper molded part at the connecting place is 0.5 mm, then the groove rod height (with equal sharing of the connecting conductor height) is 3 mm. For example, if the grooves have an overall height of 12 mm, four coil turns are required to fill the grooves with current-carrying conductors. Considering the possible thickening of the upper molded part at the connecting place to be 0.65 mm, for example, in the given soldering process, the resulting height of the groove rod is 3.9 mm, so that only three (instead of four) winding turns suffice for filling the groove coils taken as example. Thus adoption of the described soldering process makes possible machine constructions in which the winding—with otherwise the same dimensions—has fewer coil turns and can therefore be manufactured with less effort because fewer electrical connections have to be made. On account of the increased groove rod height the groove rods have a square cross-section shape in some embodiments and even a rectangular cross-section shape in other embodiments, whereby the longer sides of the rectangles extend in the depth direction of the groove (that is, in general, in the radial direction of the electric machine).

In some of the embodiments the soldering current is measured during the soldering process and the quality of the soldered connection is assessed therefrom. For example, if in individual cases the contact resistance between the soldering electrode and the molded part is too large, this can have the consequence that the soldering current which flows is too small for complete melting and merging of the solder of the two molded part surfaces. For example, the soldering current can be measured by measuring the magnitude of a voltage drop in the soldering current source or by measuring a magnetic field produced by the flowing soldering current. A soldering current which is too small can be detected, for example, in that the integrated soldering current during a soldering process does not exceed a predetermined threshold value, or in that the momentary current magnitude does not exceed a predetermined minimum value for at least a predetermined minimum time.

In some embodiments the molded part pairs which are to be soldered together are soldered one after the other with the help of a single soldering apparatus. For example, the soldering apparatus can be stationary and the stator with the winding which is to be constructed can be arranged to rotate with respect to the soldering apparatus. A newly inserted partial winding layer can thus be soldered step by step by turning progressively, e.g. through twice the groove separation in each step.

A multiple soldering apparatus is used in other embodiments, with which several or all connecting places of a layer or partial layer of molded parts are soldered simultaneously in the manner described here.

In some embodiments the manufactured winding is intended for an electric machine which is to be used as starter generator in a motor vehicle. In some embodiments this is a so-called crankshaft starter generator, that is an electric machine without own bearing, seated on the crankshaft or on a crankshaft extension of the internal combustion engine. In some embodiments the rotor is coupled to the crankshaft in rotationally rigid manner, i.e. it permanently rotates at the same speed as the internal combustion engine, whereas in other embodiments a clutch or a step-up/step-down gear transmission system (e.g. in the form of a planetary gear system) is interposed between the crankshaft and the rotor of the electric machine. Such a crankshaft starter generator generally has a disk shape, i.e. the diameter of the stator is greater than its axial length. In other embodiments the starter generator is equipped with its own bearings and located at a suitable position in the engine drive system or placed in a subsidiary drive system which can be coupled to the engine drive system. The mentioned electric machine with own bearings, too, can have the disk form defined above.

The continuous power rating of such starter generators generally lies in the range from 4 kW to 50 kW. Apart from its function as generator and direct starter (i.e. starter which can start-up the internal combustion engine from standstill, rotating with the same rotation speed or with the same relative rotation speed as the engine), the electric machine also serves in some embodiments as booster which assists the internal combustion engine for driving the vehicle, as sole traction motor on runs without internal combustion engine and/or as recuperation brake for the vehicle, to convert the mechanical braking energy to stored electric energy. Compared with customary stationary drive systems, such electric machines are subjected to particularly great stress, on account of the large range of the actually demanded power in operation and the arduous environmental conditions.

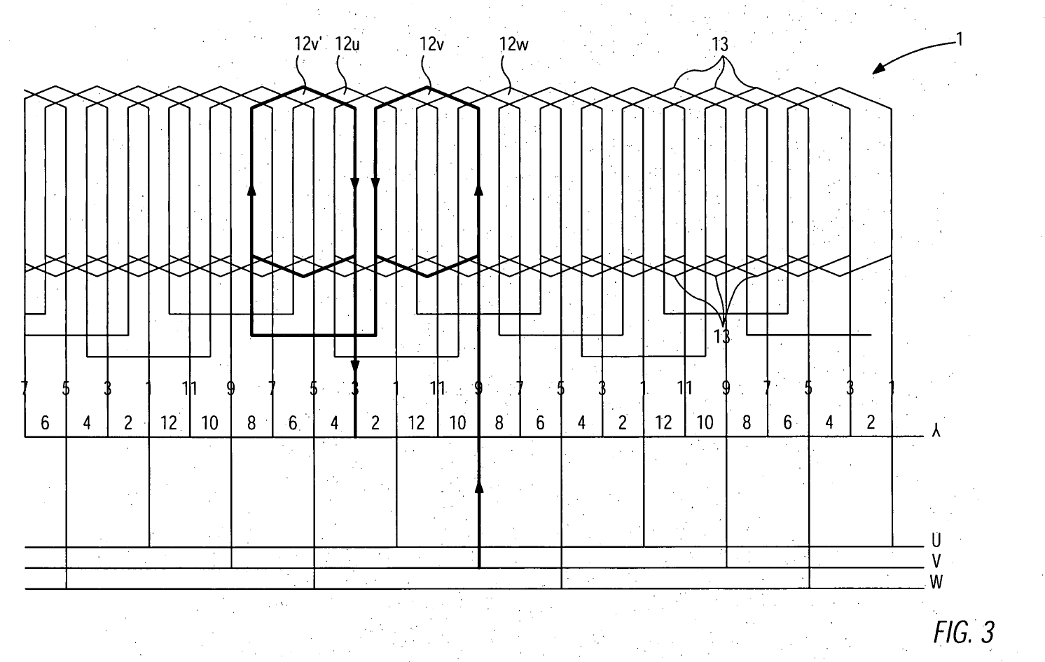

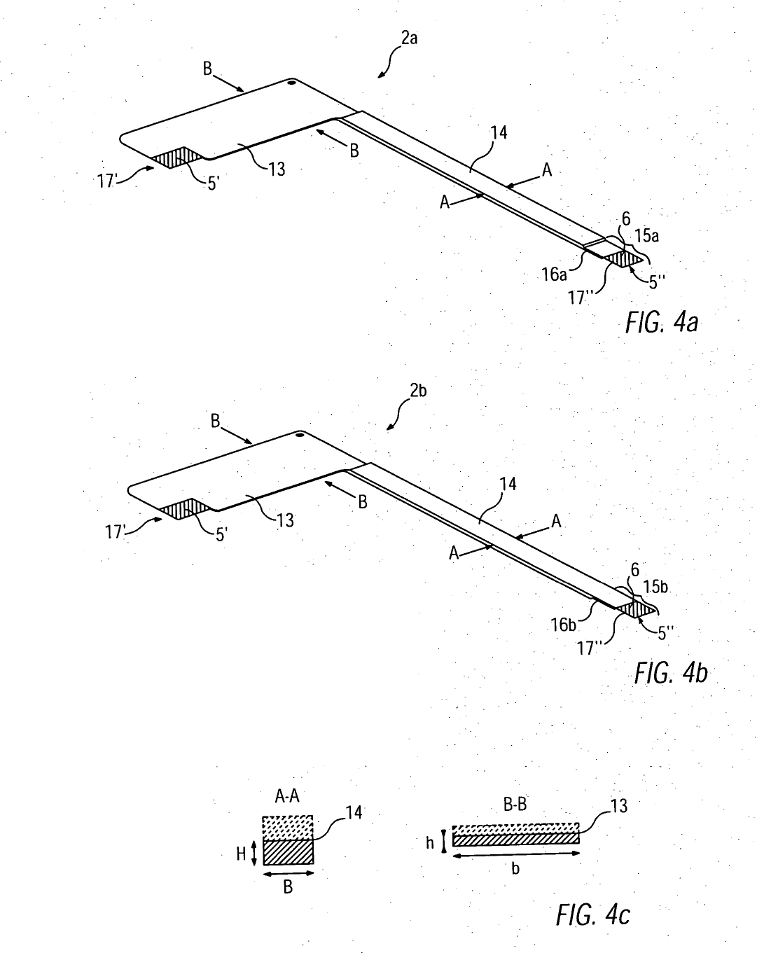

Returning now to FIG. 1, the latter illustrates the soldering process in a cross-section view of a part of a winding 1 under construction which is here depicted flat for better understanding. The winding 1 is constructed with individual molded parts 2, as explained below in more detail by reference to a winding example in connection with the FIGS. 3 to 7. As will also be explained below in more detail, the winding 1 is built-up in layers; in the depiction according to FIG. 1 two such winding layers 3.1, 3.2 have already been assembled completely and soldered, whereas a third winding layer 3.3 is just being constructed. In this layer 3.3 two molded parts 2′, 2″ are brought together such that they lie on each other with one connecting surface 5′, 5″ each at the connecting place 4. In the shown example both connecting surfaces 5′, 5″ have been pre-tinned. The upper one of the two molded parts at the connecting point, namely the molded part 2″, is made electrically conducting on its top side in the region of the connecting place 4; this electrically conducting surface region serves as contact surface 6 for two resistance soldering electrodes 7. In some embodiments the contact area 6 is pre-tinned too, to improve the electrical contact, even though no soldering as at the contact surfaces 5 takes place here. The entire remaining surface area of the molded parts 2, except for the respective connecting and contact areas at the other ends (FIG. 4), is covered with an insulating lacquer.

Now, to solder together in the described manner the molded parts which have been brought together, the two resistance electrodes 7 are pressed onto the contact area 6 of the upper molded part 2″ at the connecting place 4, in each case with a force F. The individual electrode force F is 0.05 to 0.15 kN per electrode, for example 0.1 kN. This presses the upper molded part 2″ onto the lower molded part 2′ (with a total force of 0.1 kN to 0.3 kN, for example 0.2 kN), and this in turn is pressed onto the already built molded parts layers 3.1, 3.2 lying below. The pressing force is finally taken up on the bottom molded parts layer 3.1, for example by the stator in which the layers 3 are inserted; alternatively it is also possible to support the lowest molded parts layer 3.1 at the side, with a support for its parts which project out of the stator. The pressing-on of the soldering electrodes 7 and the opposing reaction force exerted by the already built molded parts layers 3.1, 3.2 press together the molded parts 2′, 2″ which are to be connected, at the connecting place 4. Very large pressing forces could squeeze out the solder between the molded parts to be soldered, during the soldering process.

A suitable soldering voltage from a soldering generator 8 is then applied to the resistance electrodes 7, so that an electric current flows chiefly in the upper molded part 2″ in the region of the connecting place 4. For example, direct current, alternating current or halfwave-rectified current can be used. When using alternating current or halfwave-rectified current, the integrated current flow (i.e. the transported charge quantity) can be controlled in simple manner by stipulating the number of fullwave or halfwave cycles per soldering process with fixed voltage amplitude. The current flowing in the upper molded part 2″ heats this part directly in the region of the connecting place. By thermal conduction across the soldering interface this also indirectly heats the lower molded part 2′ in the region of the connecting place, so that the solder applied to the connecting places by pre-tinning melts. After a so-called hold time the soldering current is switched off. The soldering electrodes 7 are still pressed-on until the solder has solidified again. Thereafter the soldering electrodes 7 are lifted off and moved onto the next connecting place which is to be soldered, where the described procedure is repeated.

The soldering generator 8 is equipped with a soldering current analyzer 9 which, as explained above, measures the current flowing during the soldering process and, if required, integrates the measured current over the time of the soldering process and assesses the quality of the soldered joint from the result. In some embodiments this soldering current analysis only has a monitoring function, i.e. if an improper current flow is detected, a corresponding message is issued to an operator supervising the soldering process. In other embodiments the soldering current analyzer 9 is coupled to a control unit 10 of the soldering generator 8 so that when possible a corrective intervention is made still during the soldering operation. For example, when the soldering operation is normally carried out with a preset number n of halfwaves (for example 6 halfwaves), the soldering process can be continued for a further m halfwaves (for example 3 further halfwaves) if insufficient current flow is detected during the first n halfwaves, depending on the result of the soldering current analysis for each soldering process.

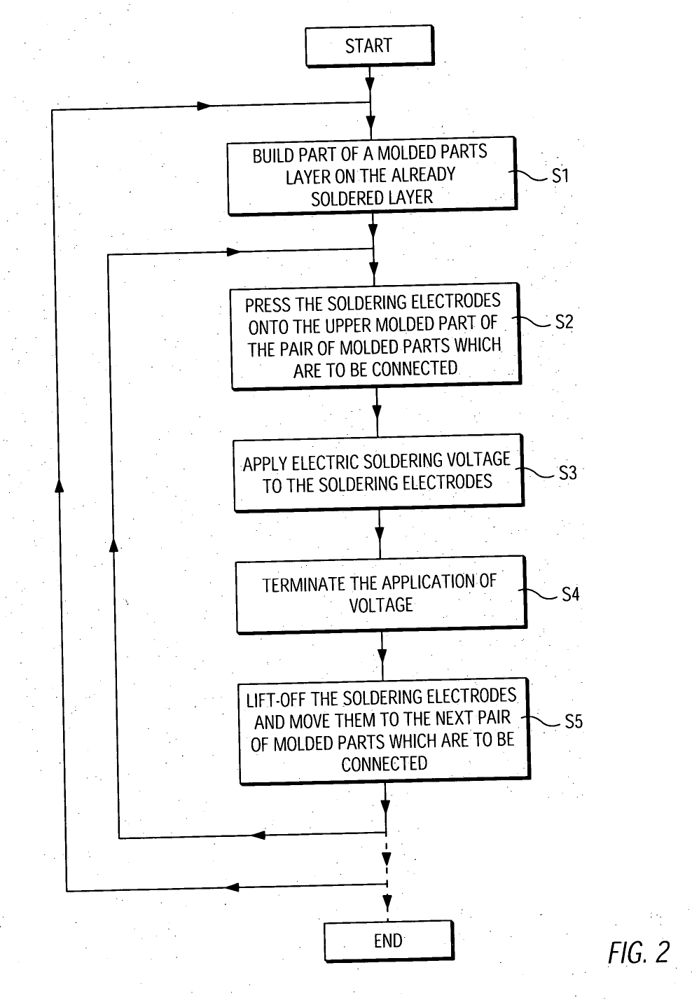

The process action sequence described above is depicted in FIG. 2 in the form of a flow chart. First of all a section of a molded parts layer is built onto an already soldered layer of molded parts (S1). As will be explained in more detail below in connection with the following FIGS. 4 to 7, this section may made up of every second molded part of a layer, for example the molded parts which are to be soldered onto molded parts of the already soldered layer lying below. Then the soldering electrodes are pressed from above (i.e. from the accessible side) onto the upper molded part of a pair of molded parts which are to be connected together (S2). Thereafter electric soldering voltage is applied to the soldering electrodes (S3). The soldering current which now flows melts the solder between the connecting surfaces of the two molded parts. After elapse of a hold time the application of voltage is terminated (S4). After the solder has solidified, now connecting the two molded parts together, the soldering electrodes are lifted off and moved to the next pair of molded parts which are to be connected (S5). The sequence S2 to S5 is repeated until all molded parts of the particular section of the molded parts layer have been soldered as required. Then a further section of a molded parts layer is mounted (S1), for example the other half of the molded parts still missing for completing the present layer, which are now soldered onto the just inserted molded parts. The sequence S2 to S5 follows again for these molded parts of the second section of the molded parts layer. The sequence S2 to S5 is repeated until all layers of the winding have been completed.

The following FIGS. 3-7 show in detail the build-up of an example of a molded parts layer using the procedure described above.

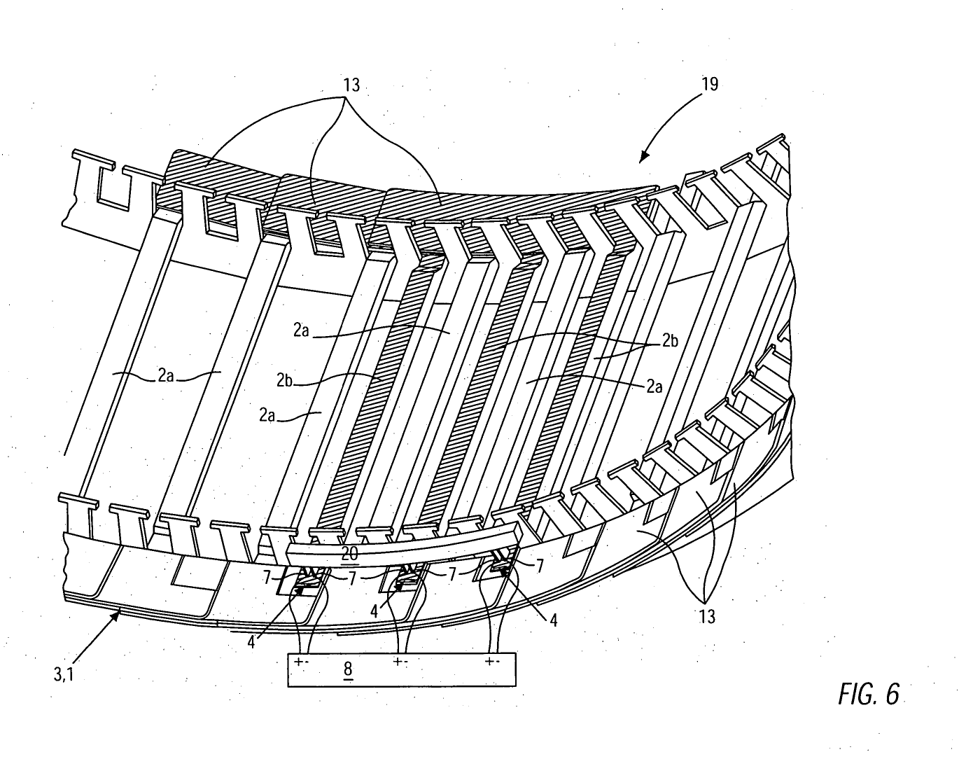

FIG. 3 shows a winding pattern of such a winding 1 as example carried out with three phases. The winding pattern repeats every twelve grooves of the stator (FIG. 6). The coils 12u, 12v, 12w belonging to the different phases U, V, W are arranged overlapping. Each coil 12 has two oppositely extending conductor sections (so-called coil sides) in two grooves, and the connecting conductors 13 connecting these conductor sections on the outside of the stator. In the depicted example the winding 1 is constructed such that the connecting conductors 13 of at most three coils 12 pass over each other, whereby for example in each case four coil sides of coils 12 of other phases lie between the coil sides of one coil 12.

Basically all coils 12 of one phase can be connected in parallel or in series; in addition thereto series-parallel connections are possible too. FIG. 4 shows an example of such a series-parallel arrangement in which in each case two neighboring coils 12 of a phase are connected in series and all coil pairs of a phase constructed in this manner are connected in parallel. For visualization such a series connection is emphasized bold in FIG. 4, namely the series connection of the coils 12v and 12v′. For further details of the winding pattern reference is made to the document U.S. 2004/0046475 A1 mentioned at the outset.

A winding of the type shown in FIG. 3 is made up of individual molded parts which each constitute sections of coil windings. The soldering of these sections already described above in detail produces a complete winding with helical coils.

In an exemplary embodiment according to FIG. 4 the winding 1 is built with L-shaped molded parts 2 which respectively comprise a groove rod 14 and a connecting conductor 13 attached thereto at right angles. Two L-shaped connecting conductors 2 give a complete coil turn (i.e. extending over 360°); thus each molded part 2 is a half turn. In the embodiment described in detail below the winding 1 can be built with essentially only two different types of molded parts 2, of which one type (2a) is shown in FIG. 4a and the other type (2b) in FIG. 4b. The first type 2a is a part turn with connection to a turn of the coil lying below it, whereas the second type 2b is a part turn which belongs to the same turn as the first part turn.

The connecting conductors 13 are made flatter and broader than the groove rods 14, as illustrated by the cross-section views according to FIG. 4c. Actually, the groove rods 14 have a height H and a width B, whereby the latter is chosen, for example, such that the groove rod 14 fills a groove in the width dimension. The height of the connecting conductor 13 is, for example, a third of the height H of the groove rod 14, whereas conversely the width b of the connecting conductor 13 is three times as large as the width B of the groove rod 14. Thus the conductor cross-section is approximately the same in the groove 14 and for the connecting conductor 13. The bottom sides of the groove rod 14 and of the connecting conductor 13 lie on the same level, but the top side of the groove rod 14 lies higher than the top side of the connecting conductor 13 by the difference H-h. As mentioned above, in some embodiments molded parts are used which are thicker than those customary so far according to the state of the art, so that the groove rods 15 for example have a rectangular cross-section with the longer rectangle side in the groove direction (radial direction), as shown in FIG. 4c with broken lines.

On the free end of the groove rod 14 the molded parts 2 comprise a flattened tongue 15 whose thickness in the connecting region 16 is approximately equal to the height h of the connecting conductor 13, and in a directly following base region 17″ it is only a fraction of the height h, e.g. half or 0.4 times the height h. For the first molded part type 2a shown in FIG. 4a the base region 16a of the tongue 15a lies at the same height as the connecting conductor 13, i.e. at the bottom side of the groove rod 14. But for the second molded part type 2b shown in FIG. 2b the tongue 15b lies at the upper side of the groove rod 14. For both molded part types the transition between the sections 16 and 17″ is a step which for both molded part types lies at the bottom side of the tongue 15. The base region 17″ thus in each case leaves on the bottom side a free space with a height of approximately a sixth of the groove rod thickness with respect to the base region 16. This bottom side in each case constitutes the connecting surface 5″ of the upper molded part 2″ at the connecting place, which is soldered in the manner explained in FIGS. 1 and 2 to the complementary connecting surface 5′ of the bottom molded part 2′ of the same winding layer 3 or of a layer lying below or above.

At the free end the connecting conductors each comprise a connecting region 17′ for which the height of the connecting conductor 13 is reduced in the region of the top side to, for example, half or 0.6 times the height h of the connecting conductor 13. The top side of this connecting region 17′ or part of it constitutes the connecting surface 5′. The sum of the thicknesses of the connecting region 17″ at the tongue 15 of the groove rod 14 and of the connecting region 17′ on the connecting conductor 13 is chosen such that it approximately corresponds to height h of the connecting conductor.

The molded parts 2 have an insulated surface which is formed, for example, as a layer of enamel insulation. However, the connecting surfaces 5′ and 5″ do not have an insulated surface, nor does the contact surface 6 which lies on the upper side of the tongue 15 of the groove rod 14 and approximately coincides with the connecting surface 5″. One or both connecting surfaces 5′, 5″ are for example plated with solder, for example tinned. The contact area 6, too, can be tinned.

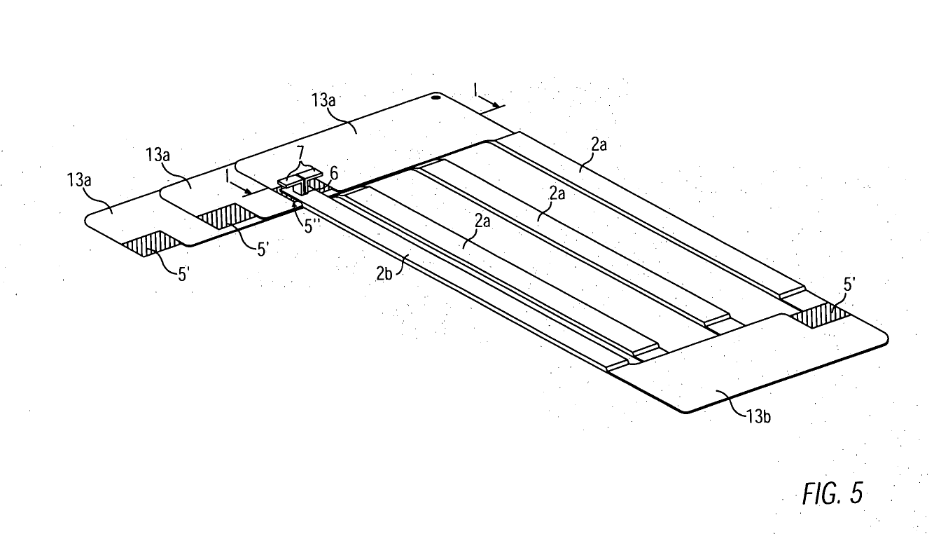

FIG. 5 explains the layer structure of the example winding with overlapping coils made out of molded parts according to FIG. 4 with the soldering procedure according to FIGS. 1 and 2. The view designated as “I-I” in FIG. 5 corresponds to the side view of the uppermost molded parts layer 3.3 and the soldering electrodes 7 of FIG. 1. For simplicity, the molded parts 2 are depicted here—as in FIG. 1—without the stator body and lying on a flat surface; in a stator body of a radial field machine they would instead be located on the inside mantle surface of a cylinder (FIG. 6). It is assumed that at least one winding layer has already been built, so that the depicted winding layer is a further layer (for example the third layer of FIG. 1) (the first winding layer can namely comprise special features with regard to the connection of the molded parts, for example as explained in the document U.S. 2004/0046475 A1 mentioned at the outset).

First of all, in a first pass, a molded part of the first type 2a is inserted into every second groove. As shown in FIG. 5, the connecting conductors 13a of in each case three molded parts 2a overlap like fish scales. The connecting surfaces 5′ on the connecting conductors 13a remain freely accessible in this fish scales like arrangement. With the in each case other connecting surface 5″ on the end of the groove rod tongues 15, these initially inserted molded parts 2a lie on the other face side of the stator on the connecting surfaces 5′ of the molded parts which lie below (this is covered in FIG. 5 by an already depicted molded part 2b of the second type). The connecting surfaces 5′ and 5″ which lie on top of each other are soldered together with the soldering electrodes by the soldering procedure described in FIGS. 1 and 2; actually the two electrodes 7 are pressed from above onto the contact surface (covered in FIG. 6) on the tongues (not shown in FIG. 5). Thereby it is optionally possible in each case, after inserting a molded part 2a, to immediately make the soldered connection to the respective molded part 2b which lies below, or first of all to mount several or all molded parts of the first type 2a for a layer in the depicted manner on the previous layer, and then (for example in a single pass) to make the soldered connections with the molded parts 2b of the layer below.

Now a molded part of the second type 2b is inserted into each groove which remained free in the first pass (that is, again every second groove, but offset by one groove relative to the first pass). The molded part 2b is oriented such that relative to the depiction in FIG. 4b it is turned through 180 degrees in the plane defined by the molded part. The insertion is here made such that now the connecting conductors 13b lying on the other face side of the stator overlap like fish scales. The overlap direction is opposite to that of the molded parts of the first type 2a (for example the overlapping of the molded parts of the first type 2a in FIG. 5 progresses from left to right and that of the molded parts of the second type 2b progresses from right to left). The tongues 15 of the molded parts of the second type 2b now come to lie with their connecting surfaces 5″ on the connecting surfaces 5′ of the previously inserted molded parts of the first type 2a. In FIG. 5 this is shown as example for a molded part of the second type 2b. The connecting surfaces 5′, 5″ lying on top of each other are here too soldered together with the soldering electrodes 7 according to the soldering procedure described above, as illustrated in FIG. 5. Again it is optionally possible to make the soldered connection to the corresponding molded part 2a immediately after inserting a molded part 2a, or to first of all insert several or all molded parts of the second type 2b for the layer concerned, and to make the soldered connections to the molded parts 2a of the considered layer thereafter. The connecting surfaces 5′ on the connecting conductors 13b of the molded parts of the second type 2b remain accessible here too. They constitute the connecting surfaces to which the molded parts of the first type 2a of the next layer will be connected, again as described above.

By the way, the two molded parts 2a and 2b connected together in this way lie, in spite of the height offset of the tongues 15a, 15b relative to the connecting conductors 13a, 13b shown in FIGS. 4a and 4b, on the same level in the winding 1, because the connecting conductors are skewed by the fish scale like configuration, by an amount just compensating the height offset. Thus the two connected together molded parts 2a and 2b constitute a 360° turn of a coil 12 in a plane which overlaps with other coils 12. Further build-up of the mutually overlapping coils 12 is made by mounting and soldering further layers of molded parts.

FIG. 6 shows a perspective view of a section of the stator 19 of an electric machine in which the build-up of the exemplary molded parts winding according to FIGS. 3-5 is made with the help of a multiple soldering apparatus 20. FIG. 6 shows a processing status in which for the bottom winding layer 3.1 all molded parts of the first type 2a and three molded parts of the second type 2b have been inserted into the grooves 21 of the stator 19 (for improved clarity the latter are depicted with shaded surface). Other than the FIGS. 1, 4 and 5, FIG. 6 no longer depicts the idealized flat roll-off, but instead a curved winding build-up, as present for example in a radial field machine with inside rotor construction type. To make the actual winding better visible, only the face sides of the stator 19 have been depicted. However, the stator 19 is usually a packet of sheet metal stampings stacked in the axial direction; thus the depicted face sides of the stator 19 are respectively the outermost sheet metal stamping of the stampings packet.

Several soldered connections can be made simultaneously with the schematically depicted multiple soldering apparatus 20. For this purpose the soldering apparatus 20 comprises a plurality of resistance soldering electrode pairs 7 which are arranged with a spacing corresponding to the spacing of the connecting places 4 which are to be soldered and whose arrangement also corresponds, if required, to the curved arrangement of the connecting places 4. In the example shown in FIG. 6 the multiple soldering apparatus 20 comprises three correspondingly arranged pairs of resistance soldering electrodes 7. Accordingly, the multiple soldering apparatus 20 with its soldering electrodes 7 simultaneously makes contact with three connecting places 4 on the contact surfaces; thus three soldered connections are made according to the method shown in FIGS. 1 and 2 in a single working step. In other embodiments the multiple soldering apparatus is designed for simultaneous soldering of a greater number of molded parts, for example for soldering all molded part pairs on one side of the stator 19. In this case the soldering electrodes are arranged, for example, approximately on a circular line, and they can be moved in suitable manner outwards (away from the center of the circle), so that the soldering apparatus 20 is moved inwards like a ring with diameter smaller than that of the stator 19 into the ring constituted by the connecting conductors 13. The soldering electrodes 7 are then moved radially outwards against the contact surfaces located thereon, so that the simultaneous soldering operation can be carried out. This permits, for example, soldering of a winding with four winding layers in only eight such soldering working steps.

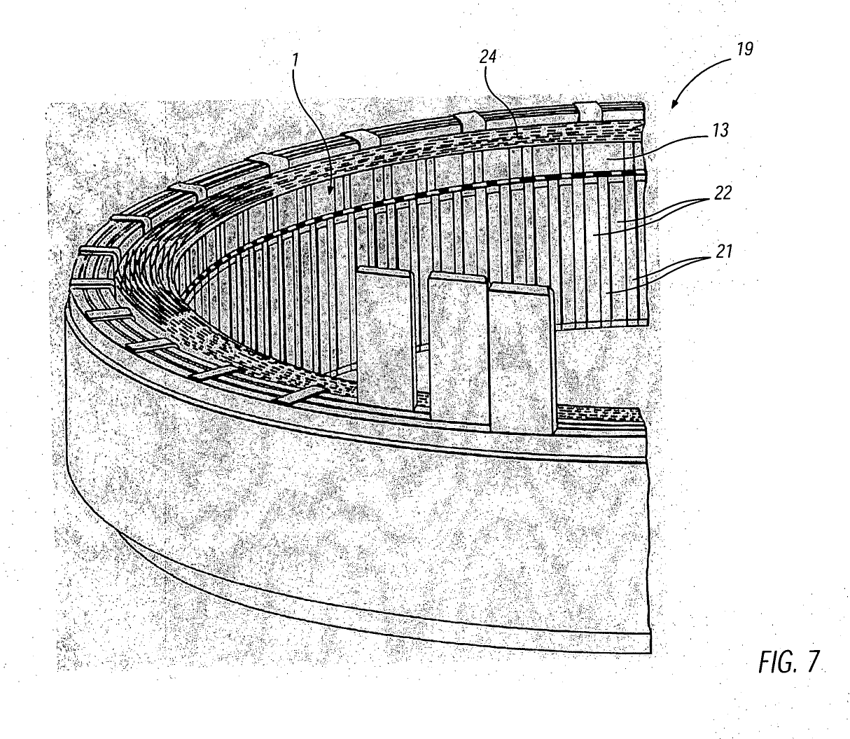

FIG. 7 shows an embodiment example of a part of a stator 19 with completely built winding 1. Groove heads 22 are visible which together with the air gap of the electric machine delimit the stator surface and behind which the grooves 21 filled with molded parts extend radially outwards. The connecting conductors 13 of the soldered together molded parts 2 constitute a connecting conductors packet 24 annularly surrounding each face side of the stator 19.

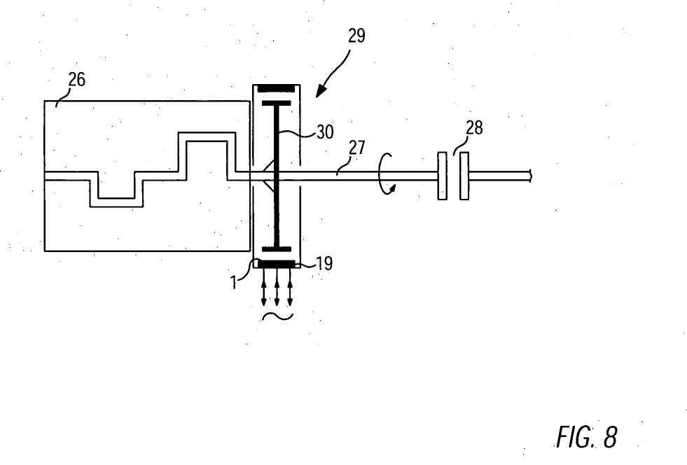

The electric machine whose winding is manufactured by the described method is, for example, a combination starter generator of a motor vehicle with internal combustion engine. For example, the starter generator is a so-called crankshaft starter generator whose rotor is seated directly on the crankshaft or on a crankshaft extension of the internal combustion engine and, for example, permanently rotates with the crankshaft, without any intermediate transmission. FIG. 8 illustrates a motor vehicle drive system with a crankshaft starter generator manufactured by the soldering method of this patent. Actually, this drive system incorporates an internal combustion engine 26 which transmits the torque to the driven wheels of the vehicle via a drive shaft 27 (for example the crankshaft), a clutch 28 and further torque transmitting components of a drive system. The electric machine 29 operating as starter and generator, for example an asynchronous three-phase machine or a synchronous three-phase machine equipped with permanent magnets, is seated on the drive shaft 27. It comprises a rotor 30 seated rotationally rigid directly on the drive shaft 27 and, for example, a stator 19 supported torsionally rigid on the casing of the internal combustion engine 26, according to one of the embodiments described above. The electric machine 29 and the internal combustion engine 26 run permanently together; the internal combustion engine 26 is started directly without gear transmission. The winding 1 of the stator 19 is supplied with electric currents and voltages with freely adjustable amplitude, phase and frequency, for example by a polyphase inverter (for example, for a three phase winding this is a three phase inverter).

The described embodiments permit simple manufacturing of molded parts windings and of electric machines equipped with such windings.

All publications and existing systems mentioned in this specification are herein incorporated by reference.

Although certain products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. Method of manufacturing a winding of an electric machine out of molded winding parts which have connecting surfaces for soldering, comprising:
placing of one or several molded parts on an already built layer of already soldered together molded parts such that at in each case at least two connecting surfaces which are to be soldered together, with solder between them, come to lie at a connecting place, whereby the top side of the upper one of the molded parts which are to be connected is exposed in the region of the connecting place;
pressing of at least two resistance soldering electrodes onto the exposed top side of the upper one of the molded parts which are to be connected, in the region of the connecting place which is to be soldered, whereby the bottom one of the molded parts which are to be connected is pressed against the layer already built and thus the molded parts which are to be connected are pressed together at the connecting place by the resistance soldering electrodes;
applying a voltage to the resistance soldering electrodes so that a soldering current flows in the upper molded part and the resistance heating thereby produced solders together the molded parts at the connecting place.

2. Method according to claim 1, whereby the molded parts which are to be connected are pressed together at the connecting place solely by the resistance soldering electrodes.

3. Method according to claim 2, whereby the force with which the at least two soldering electrodes at the connecting place are pressed onto the top side of the upper molded part is altogether 0.1 kN to 0.3 kN.

4. Method according to claim 1, whereby molded parts are used which are equipped with an insulating surface, whereby however the surface is not insulated at the connecting surfaces and on the top side in the region of the connecting place.

5. Method according to claim 4, whereby the non-insulated surface in the region of the connecting place remains non-insulated in the finished winding and the electrical insulation with respect to the molded part lying above is constituted solely by the insulation layer on the bottom surface of the latter.

6. Method according to claim 1, whereby at least one of the molded parts which are to be connected together is pre-coated with solder at the connecting surfaces.

7. Method according to claim 1, whereby after termination of the application of voltage the pressing force of the soldering electrodes is sustained at least until the solder has solidified.

8. Method according to claim 1, whereby one of the molded parts to be connected together is made with greater area at the connecting place and the other is made there with smaller area, the smaller area one being the top one at the connecting place and the soldering electrodes thus pressing against the smaller area one.

9. Method according to claim 1, whereby the thickness of the upper molded part at the connecting place is at least 0.65 mm.

10. Method according to claim 1, whereby the soldering current is measured and the quality of the soldered connection is assessed therefrom.

11. Method according to claim 1, whereby a multiple soldering apparatus is used with which several or all connecting places of a layer of molded parts are soldered simultaneously.

12. Method of manufacturing a winding of an electric machine out of molded winding parts which have connecting surfaces for soldering, comprising:
placing of one or several molded parts on an already built layer of already soldered together molded parts such that at a connecting place which is to be soldered a connecting surface of one molded part of the already built layer and a connecting surface of the, or one of the, newly mounted molded parts come to lie on top of each other with solder in between them, whereby the top side of the upper one of molded parts which are to be connected is exposed in the region of the connecting place;
pressing of at least two resistance soldering electrodes onto the exposed top side of the upper one of the molded parts which are to be connected, in the region of the connecting place which is to be soldered, whereby the bottom one of the molded parts which are to be connected is pressed against the layer already built and thus the molded parts which are to be connected are pressed together at the connecting place by the resistance soldering electrodes;
applying a voltage to the resistance soldering electrodes so that a soldering current flows in the upper molded part and the resistance heating thereby produced solders together the molded parts at the connecting place.

13. Method of manufacturing an electric machine with a stator and a rotor, whereby the stator is equipped with a molded parts winding made according to the following method, comprising:
placing of one or several molded parts on an already built layer of already soldered together molded parts such that at in each case at least two connecting surfaces which are to be soldered together, with solder between them, come to lie at a connecting place, whereby the top side of the upper one of the molded parts which are to be connected is exposed in the region of the connecting place;
pressing of at least two resistance soldering electrodes onto the exposed top side of the upper one of the molded parts which are to be connected, in the region of the connecting place which is to be soldered, whereby the bottom one of the molded parts which are to be connected is pressed against the layer already built and thus the molded parts which are to be connected are pressed together at the connecting place by the resistance soldering electrodes;
applying a voltage to the resistance soldering electrodes so that a soldering current flows in the upper molded part and the resistance heating thereby produced solders together the molded parts at the connecting place; and
whereby the stator equipped with the winding is assembled with the rotor to make an electrical machine.

14. Method according to claim 13, whereby the electric machine is a starter generator of a motor vehicle.
